(19) United States
(12) Patent Application Publication
(10) Pub. No.: US 2010/0159948 A1
(43) Pub. Date: Jun. 24, 2010

(54) Adaptive Networking For Power Savings

(75) Inventors: Anthony Wayne Spivey, Holly Springs, NC (US); Matthew Erling Barton, Chapel Hill, NC (US)

Correspondence Address: ROBERT PLATT BELL;REGISTERED PATENT ATTORNEY, P.O. BOX 13165, Jekyll Island, GA, 31527, US

(73) Assignee: TAPROOT SYSTEMS, INC., Morrisville, NC (US)

(21) Appl. No.: 12/634,966

(22) Filed: Dec. 10, 2009

Related U.S. Application Data
(60) Provisional application No. 61/139,385, filed on Dec. 19, 2008.

(51) Int. Cl. H04W 64/00; G08B 1/08

(52) U.S. Cl. 455/456.1; 340/539.13

(57) ABSTRACT

An adaptive networking system for power savings which applies to distributed computing systems includes a computing device which runs Adaptive Networking Component software which analyzes, obtains and maintains reliable network connection(s) to one or more mobile device(s) containing cooperating similar software. An Adaptive Networking Component provides power optimized, reliable network connection between a Computing device and a Mobile device. Enabled Software (for example, a communications application) uses the Adaptive Networking Component to reduce system power consumption while maintaining reliable network connections and best available user experience, compared to the power consumption, reliability and user experience when no Adaptive Networking Component(s) are available. The Adaptive Networking Component chooses between different communications transport mechanisms and communicates between connected devices to provide this service.

### CROSS-REFERENCE TO RELATED APPLICATIONS

The present application claims priority from Provisional U.S. Patent Application No. 61/139,385 filed on Dec. 19, 2008, and incorporated herein by reference.

### FIELD OF THE INVENTION

The present invention relates to mobile devices, which may have a number of networking options available. In particular, the present invention is related techniques for monitoring connection status, availability, throughput and other criteria, and adaptively making connections on transport mechanisms (network paths) as needed to improve or maintain network connectivity while minimizing power consumption, maximizing battery life, and providing acceptable network throughput.

### BACKGROUND OF THE INVENTION

Almost all modern mobile phones are capable of communicating with a computing device across a transport mechanism. Such transport mechanisms may include as a Universal Serial Bus (USB) cable, Bluetooth® connection, or cellular data, such as General Packet Radio Service (GPRS), 3G, (third generation of tele standards and technology for mobile networking), Evolution-Data Optimized (EVDO). Many mobile and computing device 100s are equipped with wireless communication capability (for example, Wireless LAN or WLAN standards such as Wi-Fi).

At the same time, applications, which in the personal computer age have traditionally been run on a single device, are increasingly becoming distributed applications that share functionality between a computing device (or multiple computing devices) and peripheral device(s). Mobile ad-hoc Wi-Fi router or “hotspot” applications are examples of such distributed applications. For example, a laptop or other computing device may be reliant on the mobile phone running an ad-hoc router application that acts as a gateway to the Internet. Other examples may include using a mobile phone with a touch screen as (i) a media remote, (ii) an input device such as a credit card signature pad, (iii) a remote control for a home security system, (iv) an ultra long range baby monitor, or (v) a portable television screen to stream media from a computing device acting as a server. As users begin to rely more and more on mobile devices as computing device peripherals, conserving power while maintaining reliable connectivity is a high priority.

The distinction between mobile phones, mobile computing devices, laptops, messaging devices, personal digital assistants, and the like is becoming increasingly blurred as users rely on different types of devices for the same or similar purposes. For example, one can download and read e-mail messages on a traditional laptop computer, or use a text-enabled mobile phone device or an internet enabled mobile phone device. Mobile phones have increased in size and may be provided with built-in or add-on keyboards. Laptops, particularly so-called netbooks, have shrunken in size and increasingly are being used a telephony devices (e.g., Skype, or the like). For the purposes of this application, the term “mobile device” may encompass one or more of these type of devices and is not limited to one particular embodiment. Consumers are proving to be platform-agnostic, which is to say that they may not care which of a particular device they use to send and receive data, voice or the like. Regardless of platform used, however, consumers dislike having to manually configure networks to communicate with a device. Consumers also demand the highest data bandwidth possible and also want increased battery life.

Current technology used in mobile devices either manually or automatically makes an initial connection but does not provide automatic or adaptive changes to that connection as the connectivity environment changes. When a network connection is lost on a personal computer or smartphone, for example, the user often must take manual steps to attempt to restore the connection, or choose a different method of connecting. As an example, the Microsoft Windows XP® ‘Network Connections’ menu provides a ‘Repair’ selection for each separate network connection, which a user must manually select in order to re-attempt network connection. As an example, a smartphone with both USB and WiFi capability, running with the Windows Mobile® operating system, offers the user a list of available WiFi connections, one or more of which must be manually selected. It may be difficult for the user to guess which connection is best to use.

Failover from one communication path to another is a common practice in telecommunications networks and high-end computer systems. Failover is the capability to switch over automatically to a redundant or standby computer server, system, or network upon the failure or abnormal termination of the previously active server, system, or network. Failover happens without human intervention and generally without warning, unlike a manual switchover. One example is the usage of redundant connections with automatic switchover. For example, McGee, et al., U.S. Pat. No. 7,460,470, issued on Dec. 2, 2008, and incorporated herein by reference, discloses a system and method of priority failover determination. McGee teaches a method of prioritizing ranking criteria for a plurality of redundant network adapter ports.

A Virtual Private Network (VPN) may also provide a resilient network connection for wireless communications across multiple network connections. For example, Myers, et al., U.S. Pat. No. 7,450,940, issued on Nov. 11, 2008, and incorporated herein by reference, discloses such a wireless network communication system and method. Myers teaches a method for providing continuous communication service for a mobile unit as it roams within a virtual wireless network.

Zhodzishsky, Published U.S. Patent Application 2008/0279129, incorporated herein by reference, discloses a system and method for automatic wireless transport selection for increased performance and reduced power consumption. Multiple wireless transport services can appear to a TCP/IP stack as a single adapter. Management of the multiple wireless transport services can be performed below the TCP/IP stack to optimize on criteria such as power consumption and bandwidth. The Zhodzishsky application, however, is limited to wireless transport services.

Baron, Published U.S. Patent Application 2009/0285190, incorporated herein by reference, discloses methods and systems, which identify and interact with network interfaces based on the network to which they provide access. A computing device may examine available network interfaces and identify the network to which the network interfaces provide access, and perform networking tasks on interfaces based on the network identified. By managing connectivity in terms of destination networks, redundant connections may be avoided, such as in the case where a computing device would connect to a network via a wired network interface and to the same network via a wireless network interface. The destination network of both network interfaces could be identified and only a single connection established. Doing so saves on power consumption for a computing device, lowers a risk of security breach for the computing device because there are fewer connections open, and limits the consumption of network resources (e.g., Internet Protocol (IP) addresses) in the destination network.

For mobile devices, selecting a network based on availability alone may be problematic. For example, for a mobile device in a moving vehicle, selecting a network based on signal strength or the like and switching to that network may be short-sighted, as the device may be out of range of that network (e.g., WiFi hot spot) when the vehicle moves). Devices such as that of Zhodzishsky do not compensate for such movement and thus may be prone to switching back and forth between networks as they come in and out of range. As a result, unnecessary switching and possible signal loss may occur. It remains a requirement in the art to provide a method and apparatus for allowing a mobile device to switch seamlessly between networks, including hard-wired and wireless networks, in a manner that is transparent to the user, to provide optimal bandwidth and/or optimal power consumption, while avoiding switching to wireless networks that are transient in nature.

### SUMMARY OF THE INVENTION

The present invention monitors connection status, availability, throughput and other criteria, and adaptively makes connections on transport mechanisms (network paths) as needed to improve or maintain network connectivity while minimizing power consumption, maximizing battery life, and providing acceptable network throughput. The ability to hide the loss of connection, and then automatically create a substitute connection, is valuable to users because it minimizes disruption of their work and allows normal program operation to continue on the network or mobile device. The present invention optimizes for minimal power consumption, using both history and predictive mechanisms to be most useful to the user. It adapts to changes in the radio environment, power levels, cabling, and many other factors. More important, the present invention provides a new method and improves upon the existing methods of failover disclosed in McGee and Myers because it neither requires the implementation of a VPN nor does it require redundant (duplicate) hardware, both of which can add considerable expense to implementing such a solution.

The present invention includes a method or process for an adaptive networking system for distributed computing to conserve battery power in computing and mobile devices. A Computing device, which may be itself a mobile device, runs an Adaptive Networking Component software which analyzes, obtains and maintains reliable network connection(s) to one or more mobile device(s) containing cooperating similar software, also an Adaptive Networking Component. The Adaptive Networking Component provides power optimized, reliable network connection between a Computing device and a Mobile device. Enabled Software (for example, a communications application or an Internet browser) uses the Adaptive Networking Component to reduce system power consumption while maintaining reliable network connections and best available user experience, compared to the power consumption, reliability and user experience when no Adaptive Networking Component(s) are available. The Adaptive Networking Component chooses between different communications transport mechanisms and communicates between connected devices to provide this service.

The choice of lower-power consuming transport mechanisms typically causes a reduction in overall power consumption, assuming the reliability of the transport mechanism is adequate to meet the current needs of the user. The automatic choice of a transport mechanism which is facilitated by this invention relieves the user from spending time and attention to manually control the networking, and is therefore much more convenient for the user. In fact, many users do not even know what choices of networking are available, and so the automation of the choice of transport mechanism using adaptive networking greatly enhances the user experience.

The mobile device of the present invention (and method of operating thereof) may use GPS or cell tower locations to determine position of the device over time. If the device is determined to be moving (e.g., in a vehicle) then the device may avoid connections to stationary localize signals, such as Bluetooth or WiFi, unless such signals originate from within the vehicle itself. Thus, if a vehicle is stopped at a light near an Internet Caf, the system may decline to connect to the WiFi “hotspot” at the Caf if the system determines that the vehicle has been in motion. If the mobile device is determined to be stationary for a predetermined amount of time (e.g., the user has parked the vehicle or is at the Caf) then the system may connect to such a local network. Using position history data to select network connections avoids the possibility that the device will connect and re-connect constantly while the vehicle is in motion, and thus avoid possible interruptions in service as well as reduce system overhead due to constant reconnection of local networks.

### BRIEF DESCRIPTION OF THE DRAWINGS

FIG. 1 is a diagram illustrating the typical useable distance ranges of various transport mechanisms or communications pathways used in mobile devices.

FIG. 2 is a system block diagram illustrating the operation of the Adaptive Network System of the present invention.

FIG. 3 is block diagram illustrating the internal components within the Adaptive Networking Component.

FIG. 4 is a block diagram illustrating the internal components of the Control Logic and Control Data Store.

FIG. 5 is a block diagram illustrating the steps in determining connectivity based on position history data.

### DETAILED DESCRIPTION OF THE INVENTION

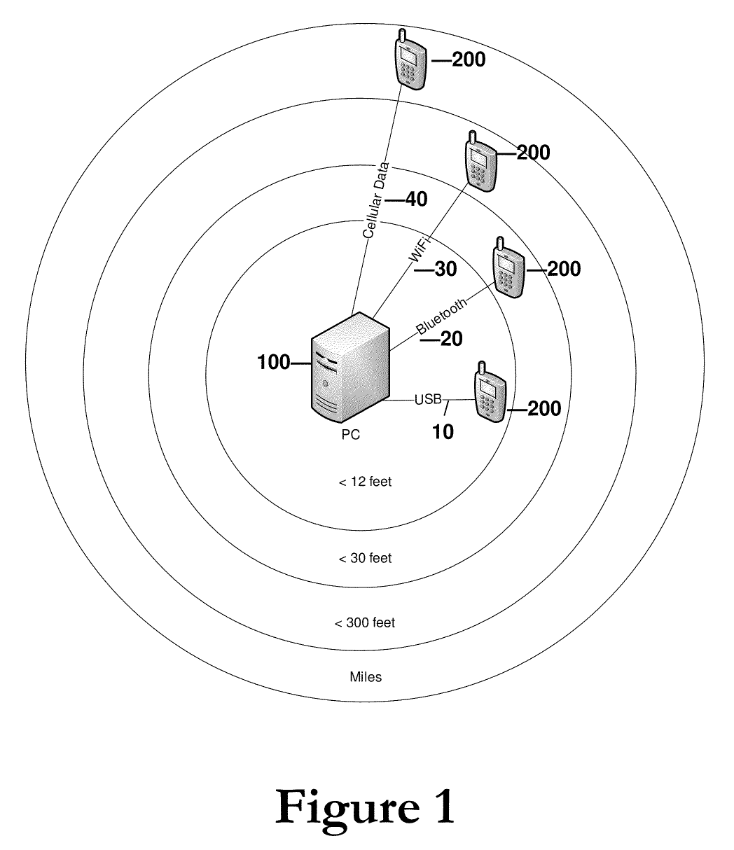

FIG. 1 illustrates the typical distance range of various data communication transport mechanisms. Each of the types of transport mechanisms (of which those listed in FIG. 1 are merely examples) has desirable features, and limitations, some of which are listed here. In FIG. 1, the relative approximate range between a computing device 100 (e.g., Personal Computer (PC)) and a mobile device 200 (e.g, cellular telephone, Blackberry® or the like) is illustrated.

USB (Universal Serial Bus) 10 provides a very high bandwidth (nominally up to 480 Mbps). Connecting a mobile device 200 using USB port 10 in effect provides negative power consumption, as mobile device 200 may receive power from USB port 10 to charge the battery or the like. USB ports 10 are widely available on computing devices 100. One major disadvantage of USB port 10 is that it has a very short range as it requires physical cable connection between the mobile device 200 and the computing device (PC) 100.

The Bluetooth® wireless connection 20 has a potentially larger range than USB port 10, due to its wireless nature. Bluetooth® connection 20 has low power consumption and is widely available on most mobile devices 200. One disadvantage of Bluetooth® connection 20 is the relatively low bandwidth (nominally up to 3 Mbps), and comparatively short range (compared to other wireless techniques, as illustrated in FIG. 1). In addition, Bluetooth® is presently not widely available on computing devices 100 such as a Personal Computer (PC).

WiFi connection 30 is also a wireless connection and has a higher bandwidth (nominally up to 50+Mbps) than Bluetooth® connection 20 and is widely available on computing devices 100. However, WiFi connection 30 suffers from high power consumption, and is not widely available on mobile devices 200.

Cellular Data connection 40 is a wireless data connection, which is widely available on mobile devices 200, and thus is a good gateway to Internet. Cellular Data Connection 40 presently suffers from relatively low bandwidth (2 Mbps in practice), is relatively is costly to use, and has spotty coverage.

Mobile WiMax (not shown) is a wireless connection that claims to work well both in-doors and out-of-doors. It has a relatively low bandwidth (nominally up to 4 Mbps), is not widely available on computing device 100 or mobile devices 200, and is not widely deployed in networks at the present time.

Considering the aforementioned data paths described in connection with FIG. 1 as representing preferred communications paths, with the innermost, lowest-power path being the most desired and the outermost, highest-power method being the least desired, the following rules may be applied, which are a typical expression of an algorithm used in this invention.

If a mobile device 200 and a computing device 100 are connected via a USB connection 10, the application on the computing device 100 may periodically check to see if the device is also available via a Bluetooth connection. For example, the computing device 100 may communicate with the mobile device 200 to say “I am connected to you on USB but I also see you on Bluetooth.” Likewise, the mobile device 200 may periodically check to see if the computing device 100 is available via Bluetooth. In addition, the two devices may update each other periodically (for example, “I see you on Bluetooth” and “Bluetooth sees you as well”).

Computing device 100 and mobile device 200 may also check for each other's presence via WiFi 20 periodically, although less frequently than the Bluetooth checks. Again, each device may communicate its results to the other device.

If USB connection 10 is broken (detected by the absence of an expected keep alive message, for instance), the data connection may failover to the next desired communication path which offers the lowest power consumption and good network throughput. In this example that network may be Bluetooth® connection 20.

If mobile device 200 and computing device 100 later detect that USB communication path 10 has been restored, the system then may return to using USB communication path 10. In this manner, a momentary interruption or unplugging of a mobile device 200 from a computing device (PC) 100 will not cause the data connection between the two devices to be severed, as the connection will automatically be switched over to the next desirable data channel.

If both Bluetooth® connection 20 and USB connection 10 fail, the system may failover to use a WiFi communication path 30, if that path is available. Thus, the consumer may remain connected between mobile device 200 and computing device 100, even after unplugging from USB port 10, and moving the mobile device 200 out of range of computing device 100. This failover between communications paths may be handled in a manner that is seamless and transparent to the user such that if the user is operating an application (e.g., browsing the Internet phone call or the like), the application will continue to operate in a manner, which is uninterrupted and seamless in operation. In addition, since the available data path is selected based in part on energy use, the battery in mobile device 200 is conserved.

Mobile device 200 and computing device 100 may continue this same pattern as each current transport mechanism fails, attempting to re-connect with the next most desirable communication path.

These failover rules can also be modified by use of other certain defined device metrics as well. For instance, if mobile device 200 dropped below a certain power threshold (e.g, battery running low), the failover from the Bluetooth® data path 20 might be to go directly to cellular data path 40 rather than WiFi data path 30, if using that path were expected to conserve battery life with reduced power consumption and provide acceptable network throughput. The determination of expected power consumption is done through engineering analysis of manufacturer's specifications, and detailed power measurement in either laboratory or field conditions, and stored in the rules database in the present invention. Other external metrics can be used to control failover such as transport mechanism reliability, cost, history, availability, bandwidth, Quality of Service, application type, IP mobility, network mobility support, and the like.

By using these adaptive algorithms, distributed applications are able to maintain communication while conserving maximum battery life on mobile device 200.

The choice of a lower-power consuming transport mechanism typically causes a reduction in overall power consumption providing the reliability of the transport mechanism is adequate to meet the current needs of the user. The automatic choice of a transport mechanism which is currently available relieves the user from spending time and attention to manually controlling the networking, and is therefore much more convenient for the user. In fact, many users do not even know what choices of networking are available, and so the automation of the choice of transport mechanism using adaptive networking greatly enhances the user experience.

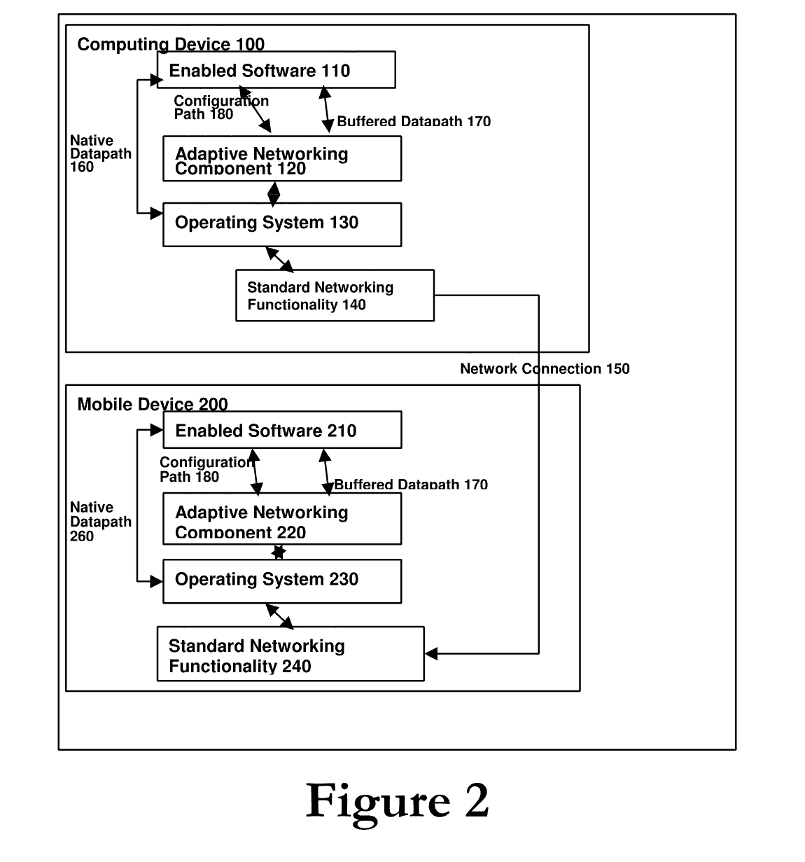

FIG. 2 is a system block diagram illustrating the operation of the Adaptive Network System of the present invention. Referring to FIG. 2, Computing device 100 (which may be itself a mobile device), is running Adaptive Networking Component software 120 that functions to obtain and maintain a power-optimized, reliable Network Connection 150 to one or more Mobile device(s) 200 containing cooperating similar software; that is, Adaptive Networking Component software 120. Adptive Networking Component 120 may also be customized for a specific operating system platform 130 (for example, MicroSoft Windows®, Symbian®, or Linux®). Adaptive Networking Component 120 maintains a power-optimized, reliable network connection between Computing device 100 and Mobile device 200.

Enabled Software 110 (for example, a communications application) uses Adaptive Networking Component 120 to reduce power consumption while maintaining reliable Network Connection(s) 150, as compared to using a communications path with a higher rate of power consumption when no Adaptive Networking Component 120 is available. Adaptive Networking Component 120 chooses among different and available communications transport mechanisms discussed above in connection with FIG. 1, and communicates information about the available transport mechanisms between Computing device 100 and Mobile device 200 to provide this service.

Enabled Software 110 and the user benefit from using Adaptive Networking Component 120 because each is being provided a reliable Network Connection 150 with minimum power consumption, which thereby maximizes the time Mobile device 200 may be used before a battery recharge is necessary. Even for non-mobile or non-battery-powered devices, the reduction in power consumption may be advantageous because it can reduce costs of electricity and environmental cooling requirements in air-conditioned environments. Enabled Software 110 may be an application, service, library or other software that has been linked, compiled, registered or otherwise enabled to make connections using Adaptive Networking Component 120.

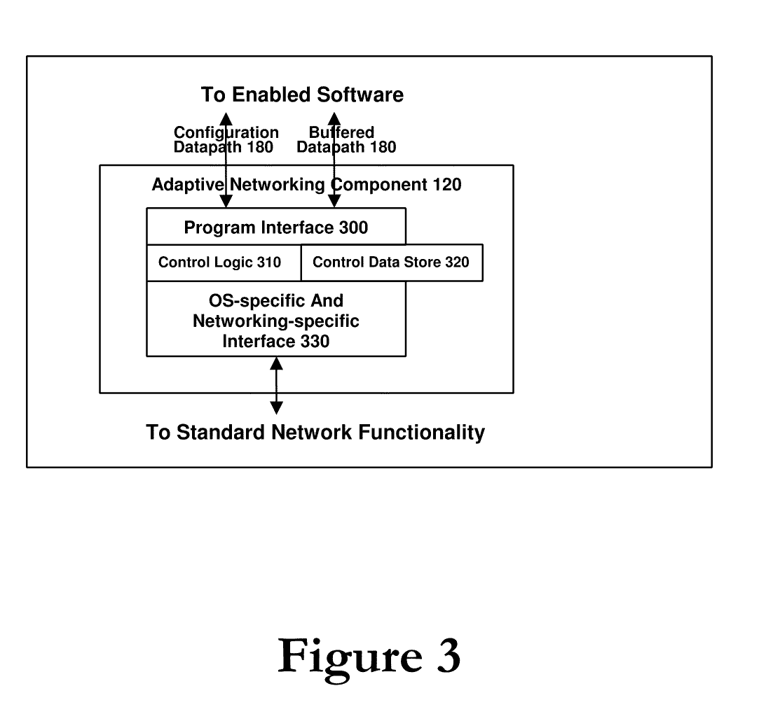

FIG. 3 is block diagram illustrating the internal components within the Adaptive Networking Component. Referring to FIG. 3, Adaptive Networking Component 120 provides a Program Interface 300 to allow registration of Enabled Software 110. The registration is typically a synchronous function call, which optionally provides data including configuration, and returns access functions for use by Enabled Software 110. The access functions provide a set of software functions, methods or objects, which allow networking data communication, including typically both configuration and send and receive of data. Many other detailed implementations are possible.

An example usage of the invention would be a Computing device 100 running a web browser application which obtains Internet access through a communications transport mechanism(s) to a Mobile device 200 running an ad-hoc router application that acts as a gateway to the Internet. Such Mobile device 200, in this example, simultaneously supports Cellular Data communication to the Internet. Thus the ad-hoc router application and the web browser application would each be Enabled Software 110/210 for purposes of this Adaptive Networking System.

For purpose of the above discussion, Computing device 100 is being used to control and set up Mobile device 200, but the operation of the Adaptive Networking System can also function with Mobile device 200 controlling Computing device 100.

As illustrated in FIG. 3, Enabled Software 110 may configure the Adaptive Networking Component 120 using Program Interface 300. Program Interface 300 can be configured via Configuration Path 180 to select a transport mechanism based on various pre-defined and/or user-defined criteria, including but not limited to, requested or targeted throughput, requested or targeted maximum error rate, Quality of Service, or other characteristics. Enabled Software 110 may also simply use Adaptive Networking Component 120 directly to control transport mechanism selection without the use of any additional metrics.

Program Interface 300 may provide a Buffered Data Path 170. Buffered Data Path 170 comprises of data transmission and reception interfaces to send and receive packets, frames, streams and other forms of data. Buffered Data Path 170 reduces the impact of network connection failure and restoration on applications and the user.

Program Interface 300 provides a Configuration Path 180. This can be optionally used by the Enabled Software to provide configuration information. When no such configuration is provided, Adaptive Networking Component 120 will operate usefully using historical or algorithmic determination of best values to apply for configurable parameters, obtained from the Control Logic 310 and Control Data Store 320.

Program Interface 300 may provide data interfaces identified as Buffered Data Path 170. When Buffered Data Path 170 interfaces exist and are used, Adaptive Networking Component 120 will direct data transfers to the correct transport mechanism through Standard Networking Functionality 140. The advantage of Program Interface 300 providing those Buffered Data Path interfaces 170 is that local buffering may be provided during changeover of transport mechanisms to reduce the disruption to applications. Such buffering is not available in Standard Networking Functionality, which is subject to loss of any unsent or unread data when disrupted.

During operation, Control Logic 310 chooses the current transport mechanism from the potentially available transport mechanisms for network connections. The primary purpose is to minimize power consumption for Mobile device 200, but, depending on also on the basis of reliability, cost, history, availability, bandwidth, Quality of Service, application type, IP mobility, network mobility support, or other factors. Enabled Software 110 may provide user preference, network operator configuration, Information Technology department configuration parameters as part of the linking or registration procedure, or subsequently via Program Interface 300. Typically usage of Program Interface 300 for configuration is absent or infrequent, since it would require additional development effort on every Enabled Software 110 package to customize this configuration.

The algorithms disclosed in the present invention maintain historical data and adaptively modifies configuration based on the success of previous network connections. Adaptive Networking Component 120 may change the active transport mechanism from time to time, based on the goal of maintaining network connection with optimized power consumption and other factors, ideally with minimal or no interruption to Enabled Software 110 usage of the network connection. Normally, before changing transport mechanism strictly for purposes of power minimization, Adaptive Networking Component 120 in each device will ensure that each device involved in the network connection is prepared to use the new transport mechanism. Control Logic 310 obtains this information either from Operating System 130 or by exchanging messages between Adaptive Networking Component 120 in Computing device 100 and Mobile device 200.

In the event that Network Connection 150 fails, each Adaptive Networking Component 120 must autonomously attempt to recover a useable Network Connection 150. This is done using the information available from each Transport Mechanism identifying the other device or access point that is in range. An example for WiFi is the list of available Basic Service Set Identifiers (BSSID) which is also commonly known as the list of available WiFi networks.

Standard Networking Functionality 140 and 240 are existing components of Computing device 100 and Mobile device 200, whether manufactured with that capability or added on later by inserting a card, adding software and/or other mechanisms for field-expanded capability. It provides access to any or all of the different Transport Mechanisms available to be used or likely to be used in mobile devices 200, including but not limited to: Universal Serial Bus (USB), Bluetooth, WiFi (802.11a/b/g/n), Cellular Data, WiMax (802.11e) and the like.

When Program Interface 300 does not provide direct data transmission interfaces, Control Logic 310 controls Standard Networking Functionality 140 in order to achieve the changes in transport mechanism necessary. An example is to direct the network stack using OS-specific and Networking-specific Interface 330 to rebind TCP/IP (Transmission Control Protocol/Internet Protocol) traffic to a USB network connection, instead of an existing WLAN connection.

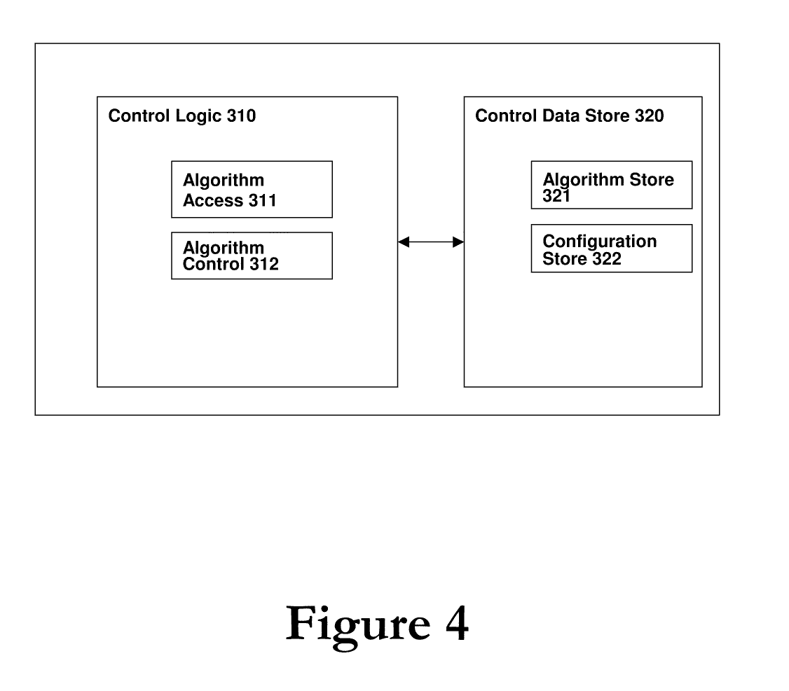

FIG. 4 is a block diagram illustrating the internal components of the Control Logic and Control Data Store. As illustrated in FIG. 4, Control Logic 310 uses Control Data Store 320, which includes Configuration Store 322 and Algorithm Store 321. The contents and structure of Control Data Store 320 may be based on current operational characteristics or historical data for any specific device, specific connection, specific user, network connected devices, type of device, type of user, type of Enabled Software 110, device power source, battery charge level, battery charging rate, battery discharge occurrences, battery replacement, cable plug/unplug events, cable type, geographic location, IP mobility support, IP address, or such other data as is conveniently obtained from either the user, the device, cables, batteries, other connected devices, or a store of historical information. Control Logic 310 includes Algorithm Access 311 and Algorithm Control 321, which make use of the Algorithm Store 321 via the Control Data Store 320.

A simple example algorithm, which may be stored in Algorithm Store 321 for use by Control Logic 310, is the following: scan for available transport mechanisms, choose the transport mechanism which is lowest in power, and start using it. If it fails, mark that transport as not-to-be-used for a future time period of N seconds, and attempt to restore network connectivity using the next lowest power available transport.

The implementation of how to use this algorithm in the invention is as follows. Provide a list of transport mechanisms which are available (even if not currently connected) in the Control Data Store 320. Order the list according to the overall power consumption expected in typical usage. Control Logic 310 selects the lowest power transport, and attempts to establish a network connection. While waiting to determine if connection is established, Control Logic 310 can also attempt to determine whether the next high power transport mechanism is at least physically present on the medium. If the lowest power connection is successfully established, start using it to transfer data for the Enabled Application.

If the connection fails, Control Logic 310 will mark the time of failure in Control Data Store 320, and also place the duration of N seconds into Control Data Store 320, and refrain from attempting to use that connection during the next N seconds, and establish a timer running so as to know when to next re-attempt the connection type. Control Logic 310 attempts to establish the next higher power connection. If such connection fails, Control Logic 310 continues the process of marking connection types as unavailable for a limited duration, and proceeds to attempting the next connection. When Control Logic 310 runs out of connection types to try, it waits until the timer indicates it is time to re-attempt making a connection. The overlapping of scanning for different connection types, and of re-attempts on connection types, is handled using state variables in the Control Data Store 320 and Control Logic 310, and through Control Logic 310, which prevents incompatible hardware or data access.

Another example algorithm which may be stored in Algorithm Store 321 for use by Control Logic 310, is the following: refine the previous algorithm by performing scans for available transport mechanisms every S seconds. This approach is specifically implemented in Control Logic 310 using a timer which triggers a scan for available transport mechanisms every S seconds, where S is a value developed and optimized based on history of connection success, protocol timeout durations, and other engineering criteria, under the theory that the power consumption used for these scans is less important than the need to be able to change transport mechanisms as may be needed in the future.

Another example algorithm is the following: Begin with the understanding that the shorter-range connection is generally lower power drain, but is subject to disconnection with user motion or external interferences by moving vehicles nearby. Knowledge of location and/or speed of movement for the devices are used to avoid changing to a short-range transport mechanism when it is predicted based on user or device speed that the short-range transport may not be useful for long. The implementation of this algorithm within the Adaptive Networking Component 120 is as follows: Use the engineering knowledge of useable range developed during engineering assessment and live usage to create a table of parameters in the Control Data Store 320.

These parameters include the connection type, default expected useful duration and range, default required useful duration. Control Logic 310 uses these parameters and others such as current location, current speed, current application(s) in use, to identify the predicted duration of a connection, and compares this duration to the available location and speed information, also entered into the Control Data Store 320. The assessment of expected duration is tunable either by changing parameters in the Control Data Store 320, or by Control Logic 310, with default being the requirement of at least 1 minute to make a data connection useable. The algorithm may depend on a history of connection durations including reference to the active application(s) to modify this default required duration parameter.

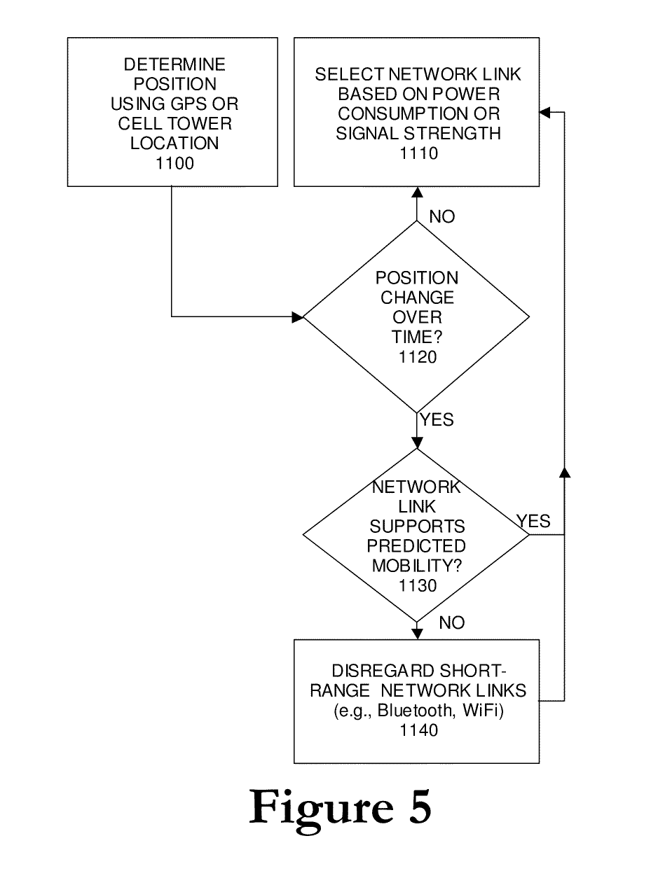

An example of how to make reference to the active application is illustrated in FIG. 5. If a GPS mapping application is started, it often hints that the user is in motion in a vehicle, and so any WiFi base station which is not co-located in the vehicle will be unlikely to stay in range. The mobile device may determine if the device is in motion from the position data, which may be obtained from a built-in GPS device, or from cell tower location data, as illustrated in block 1100. Other forms of position determination may be used within the spirit and scope of the present invention, including multilateration or the like.

In block 1120, the mobile device determines whether the position of the device has changed over time (e.g., has there been significant movement exceeding the range of a network in question over the previous predetermined number of minutes). For example, if the device has moved a quarter mile in the last few minutes, then it may be considered to be in motion and thus connectivity to a WiFi network may not be advisable. On the other hand, if the device has not moved more than a few yards in a predetermined number of minutes, the device may be considered stationary, and connection to local networks such as WiFi may be enabled in block 1110 based on other desired criteria (signal strength, power consumption).

The identity of a WiFi base station which is co-located in the vehicle is be a useful user-configured parameter and is determined in step 1130. For example, if a WiFi or Bluetooth network is provided within the vehicle, then it may be desirable to connect to such a network, even though the mobile device position is changing over time. Examples of such networks may comprise wireless networks provided in planes, boats, trains, subways, or the like, or even within personal vehicles. If predicted mobility is supported in block 1130, then the mobile device may connect to local networks such as Bluetooth or WiFi, in block 1110 based on other desired criteria (signal strength, power consumption).

On the other hand, if the local short range networks found do not support predicted mobility (e.g., they are stationary networks) then such short-range networks are ignored in block 1140. Thus, as a user travels in a vehicle or the like, the system will ignore local networks which will not provide a meaningful amount of connectivity time. If the mobile device attempted to connect to each WiFi network, for example, as a car drove down the street, the device may become overwhelmed, as it is constantly switching from network to network. A user walking, on the other hand, may be able to connect to such networks, which may conserve battery power.

The tuning is typically done via a learning mechanism, but configuration through the Program Interface 300 may over-ride the tuning algorithm. Control Logic 310 uses the parameters, history, and algorithms in Control Data Store 320 to select the network connection mechanism to attempt to activate when a new connection is required either due to failure or in order to minimize power consumption.

An example implementation of Control Logic 310 is the following: provide Control Logic 310 such that if Mobile device 200 and Computing device 100 are connected via USB transport mechanism 10, Adaptive Networking Component 120 on Computing device 100 may periodically check to see if Mobile device 200 is also visible via Bluetooth transport mechanism 20. Likewise, Adaptive Networking Component 120 on Mobile device 200 may periodically check to see if Computing device 100 is visible via Bluetooth transport mechanism 20. The two Adaptive Networking Components 120 and 220 may update each other periodically with status regarding the available transport mechanisms (e.g. “I see you on Bluetooth,” “I see you too”).

Control Logic 210 may be implemented so that Computing device 100 and Mobile device 200 may also check for each other's presence via WiFi transport mechanism 30 periodically. Typically these checks are performed at a lesser frequency, such as 1/10^{th} of the frequency of the Bluetooth check. The lesser frequency reduces the power consumption, while providing adequate notice of availability. Again, they may communicate their results regarding the status of the available transport mechanisms to each other.

If the USB transport mechanism 10 is or becomes unavailable (for example, detected by the absence of an expected keep alive message), the two Adaptive Networking Components 120 may cause the data connection to failover to the next desirable and currently available transport, in the example case this would be Bluetooth.

If Adaptive Networking Components 120 on Computing device 100 and Mobile device 200 both detect that USB transport mechanism 10 has been restored and is suitably stable, they may cause the Network Connection 150 to be re-established using USB transport mechanism 10. The criteria to determine whether a mechanism is suitable stable include but are not limited to bit error rate, packet error rate, packet loss rate, packet retry occurrence and frequency, error histogram over a limited time, throughput under trial conditions, connectivity to specific network addresses as tested or configured, indications of network conditions provided by the network operator and such other criteria as are helpful.

As another example, if both USB transport mechanism 10 and Bluetooth transport mechanism 20 fail or are otherwise not available, Adaptive Networking Components 120 may failover to use WiFi transport mechanism 30.

For purpose of the above discussion, Computing device 100 is being used to control and set up Mobile device 200, but the operation of the Adaptive Networking System may also function in the reverse direction. That is, with the Mobile device 200 controlling the Computing device 100.

In general, for any combination of transport mechanisms, Adaptive Networking Components 120 may continue the same pattern already described above as each current transport mechanism fails, and attempt to re-connect with the next most desirable transport mechanism available.

Many optimizations to these algorithms and tunable parameters in order to achieve lowest power consumption, best average throughput, fewest user-visible disconnections, and the like are available by using knowledge of user location, distance from network access points, history, and all other data either available directly or stored in the Control Data Store 320.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A method of adaptively coupling a portable communications device through at least one of a plurality of communications links, comprising:
determining the presence of at least one the plurality of communications links;
determining position of the portable communications device over time to determine whether the portable communications device has moved within a predetermined time period;
determining whether any of the at least one the plurality of communications links are short range or long range communications links, and whether short range communications links are portable with the portable communications device;
determining which of the plurality of communications links provides optimal data connection for the portable communications device while disregarding any short range communications links not portable with the portable communications device if the portable mobile communications device has moved within a predetermined time period to select one of the plurality of communications links providing an optimal data connection for the portable communications device; and
connecting the portable communications device to the selected one of the plurality of communications links determined to provide optimal data connection.

2. The method of claim 1, wherein determining position of the portable communications device over time to determine whether the portable communications device has moved within a predetermined time period comprises determining position of the portable communications device using a Global Positioning System receiver in the portable communications device.

3. The method of claim 1, wherein determining position of the portable communications device over time to determine whether the portable communications device has moved within a predetermined time period comprises determining position of the portable communications device by identifying a cellular telephone tower within range and whether cellular telephone tower identification changes over time.

4. The method of claim 1, wherein determination of optimal data connection for the portable communications device is determined by which operative data communication link has the lowest power consumption for the portable communications device.

5. The method of claim 1, wherein determination of optimal data connection for the portable communications device is determined by which operative data communication link has the highest data bandwidth for the portable communications device.

6. The method of claim 1, wherein determination of optimal data connection for the portable communications device is determined by which operative data communication link has the lowest cost to a user of the portable communications device.

7. The method of claim 1, further comprising:
determining if a communication link connected to the portable communications device is inoperative;
determining which of remaining operative communication links provides optimal data connection for the portable communications device and
automatically connecting the portable communications device to one of the remaining operative communications links determined to provide optimal data connection.

8. The method of claim 7, wherein determination of optimal data connection for the portable communications device is determined by which operative data communication link has the lowest power consumption for the portable communications device.

9. The method of claim 7, wherein determination of optimal data connection for the portable communications device is determined by which operative data communication link has the highest data bandwidth for the portable communications device.

10. The method of claim 7, wherein determination of optimal data connection for the portable communications device is determined by which operative data communication link has the lowest cost to a user of the portable communications device.

11. The method of claim 7, wherein determining position of the portable communications device over time to determine whether the portable communications device has moved within a predetermined time period comprises determining position of the portable communications device using a Global Positioning System receiver in the portable communications device.

12. The method of claim 7, wherein determining position of the portable communications device over time to determine whether the portable communications device has moved within a predetermined time period comprises determining position of the portable communications device by identifying a cellular telephone tower within range and whether cellular telephone tower identification changes over time.

13. A portable communications device adaptively coupling through at least one of a plurality of communications links, comprising:
a receiver determining the presence of at least one the plurality of communications links;
position determination system determining position of the portable communications device over time to determine whether the portable communications device has moved within a predetermined time period;
a processor determining whether any of the at least one the plurality of communications links are short range or long range communications links, and whether short range communications links are portable with the portable communications device, determining which of the plurality of communications links provides optimal data connection for the portable communications device while disregarding any short range communications links not portable with the portable communications device if the portable mobile communications device has moved within a predetermined time period to select one of the plurality of communications links providing an optimal data connection for the portable communications device; and
a network switching device connecting the portable communications device to the selected one of the plurality of communications links determined to provide optimal data connection.

14. The portable communications device of claim 13, wherein the position determination system comprises a Global Positioning System receiver in the portable communications device determining position of the portable communications device over time to determine whether the portable communications device has moved within a predetermined time period.

15. The portable communications device of claim 13, wherein the position determination system comprises a cellular receiver in the portable communications device determining position of the portable communications device over time to determine whether the portable communications device has moved within a predetermined time period by identifying a cellular telephone tower within range and whether cellular telephone tower identification changes over time.

16. The portable communications device of claim 13, wherein the processor determines optimal data connection for the portable communications device by which operative data communication link has the lowest power consumption for the portable communications device.

17. The portable communications device of claim 13, wherein the processor determines optimal data connection for the portable communications device by which operative data communication link has the highest data bandwidth for the portable communications device.

18. The portable communications device of claim 13, wherein the processor determines optimal data connection for the portable communications device by which operative data communication link has the lowest cost to a user of the portable communications device.

19. The portable communications device of claim 13, wherein the processor determines if a communication link connected to the portable communications device is inoperative, determines which of remaining operative communication links provides optimal data connection for the portable communications device and the network switching device automatically connects the portable communications device to one of the remaining operative communications links determined to provide optimal data connection.

20. The portable communications device of claim 19, wherein the processor determines optimal data connection for the portable communications device by which operative data communication link has the lowest power consumption for the portable communications device.

21. The portable communications device of claim 19, wherein the processor determines optimal data connection for the portable communications device by which operative data communication link has the highest data bandwidth for the portable communications device.

22. The portable communications device of claim 19, wherein the processor determines optimal data connection for the portable communications device by which operative data communication link has the lowest cost to a user of the portable communications device.

23. The portable communications device of claim 19, wherein the position determination system comprises a Global Positioning System receiver in the portable communications device determining position of the portable communications device over time to determine whether the portable communications device has moved within a predetermined time period.

24. The portable communications device of claim 19, wherein the position determination system comprises a cellular receiver in the portable communications device determining position of the portable communications device over time to determine whether the portable communications device has moved within a predetermined time period by identifying a cellular telephone tower within range and whether cellular telephone tower identification changes over time.
